(19) United States
(12) Patent Application Publication
(10) Pub. No.: US 2008/0317522 A1
(43) Pub. Date: Dec. 25, 2008

(54) FUSER ASSEMBLY HAVING OIL RETENTION FEATURES

(76) Inventors: Jeffrey Allen Ardery, Richmond, KY (US); Jason Kyle Romain, Versailles, KY (US); Jerry Wayne Smith, Irvine, KY (US); Fangsheng Wu, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/766,846

(22) Filed: Jun. 22, 2007

(51) Int. Cl. G03G 15/20

(52) U.S. Cl. 399/329

(57) ABSTRACT

A fuser assembly includes a first end cap, and a second end cap spaced apart from the first end cap along an axis orthogonal to a sheet feed direction. A fuser belt is positioned between and supported by the first end cap and the second end cap to rotate around the axis in a belt moving direction at the nip corresponding to the sheet feed direction. A heater assembly is located in the hollow interior of the fuser belt. A plurality of ribs is positioned to contact the interior surface of the fuser belt. A first rib is connected to one of the first end cap and the heater assembly. A second rib is connected to one of the second end cap and the heater assembly. Each of the plurality of ribs is oriented to longitudinally extend at an acute angle with respect to the belt moving direction.

### CROSS-REFERENCE TO RELATED APPLICATIONS

None.

### MICROFICHE APPENDIX

None.

### GOVERNMENT RIGHTS IN PATENT

None.

### BACKGROUND OF THE INVENTION

1. Field of the Invention

The present invention relates to electrophotographic imaging devices, and, more particularly, to a fuser assembly having oil retention features.

2. Description of the Related Art

An electrophotographic imaging apparatus, such as a laser printer, forms a latent image on a surface of a photoconductive material by selectively exposing an area of the surface to light. The latent electrostatic image is developed into a visible image by electrostatic toners which contain pigment components and thermoplastic components. The photoconductor may be either positively or negatively charged, and the toner system similarly may contain negatively or positively charged particles. A print medium (e.g., a sheet of paper) or intermediate transfer medium is given an electrostatic charge opposite that of the toner and then passed close to a surface of the photoconductor, pulling the toner from the photoconductor onto the paper or immediate medium in the pattern of the image developed from the photoconductor. After the image is transferred to the print medium, the print medium is processed through a fuser assembly where it is heated and pressed. The fuser assembly may include a fuser belt, subjected to heat, which melts and fixes the toner to the print medium surface thereby producing the printed image.

An axial location of the fuser belt is controlled by an end cap attached to each end of a heater housing. The fuser belt may be, for example, a polyimide tube having a Teflon® coating. The fuser belt is rotated by paper moving through a nip produced by a backup roller being pressed against the fuser belt. A ceramic heater mounted by the heater housing is positioned in the interior of the fuser belt. As the fuser belt is rotated, an interior surface of the fuser belt slides on the heater surface. The sliding contact between the belt and the heater surface can cause a high friction force.

To reduce this friction force, grease and oil have been commonly used as lubricants between the fuser belt and the heater. Greases normally have higher viscosity than oil, and can form a thicker film on the belt and heater surface than oil. However, the higher viscosity of grease can cause a higher friction force and driving torque, and a thicker film thickness, and in turn can cause a lower fusing grade/quality. On the other hand, oil as lubricant has a lower viscosity than grease and can form a thinner film, resulting in lower driving torque and better fusing grade/quality. However, the lower viscosity of oil causes the oil to flow easily, and the oil may leak out from the two ends of the belt, especially at high fusing temperatures. As the oil leaks out, the lubrication condition between the fuser belt and the heater becomes increasingly worse, leading to higher driving torque, higher belt wear, and sometimes to the destruction of the fuser belt.

### SUMMARY OF THE INVENTION

The present invention provides a fuser assembly having oil retention features in the form of ribs that engage an interior surface of a fuser belt.

The terms “first” and “second” preceding an element name, e.g., first side edge, second side edge, first end cap, second end cap, etc., are used for identification purposes to distinguish between similar elements, and are not intended to necessarily imply order, nor are the terms “first” and “second” intended to preclude the inclusion of additional similar elements.

The invention, in one form thereof, is directed to a fuser assembly configured to fix a toner image to a sheet of print media moving in a sheet feed direction through a nip. The fuser assembly includes a first end cap, and a second end cap spaced apart from the first end cap along an axis that is orthogonal to the sheet feed direction. A fuser belt has a first side edge, a second side edge spaced apart from the first side edge, an exterior surface, an interior surface, and a hollow interior defined by the interior surface. The fuser belt is positioned between and supported by the first end cap and the second end cap, with the axis passing through the hollow interior, to rotate around the axis in a belt moving direction at the nip corresponding to the sheet feed direction. A heater assembly is located in the hollow interior of the fuser belt. The heater assembly includes a heater housing and a heater body coupled to the heater housing. The heater body is positioned to contact the interior surface of the fuser belt. A plurality of ribs is positioned to contact the interior surface of the fuser belt. A first rib of the plurality of ribs is connected to one of the first end cap and the heater assembly. A second rib of the plurality of ribs is connected to one of the second end cap and the heater assembly. Each of the plurality of ribs is oriented to longitudinally extend at an acute angle with respect to the belt moving direction.

The invention, in another form thereof, is directed to a fuser assembly configured to fix a toner image to a sheet of print media moving in a sheet feed direction through a nip. The fuser assembly includes a first end cap, and a second end cap spaced apart from the first end cap along an axis that is orthogonal to the sheet feed direction. A plurality of ribs is positioned to contact the interior surface of the fuser belt, wherein a first rib of the plurality of ribs is connected to the first end cap and a second rib of the plurality of ribs is connected to the second end cap. The first rib and the second rib are oriented to be symmetrical.

The invention, in another form thereof, is directed to a fuser assembly configured to fix a toner image to a sheet of prim media moving in a sheet feed direction through a nip. The fuser assembly includes a heater assembly located in the hollow interior of a fuser belt. The heater assembly includes a heater housing and a heater body coupled to the heater housing. A plurality of ribs is positioned to contact the interior surface of the fuser belt, wherein a first rib of the plurality of ribs is connected to the heater body of the heater assembly, and a second rib of the plurality of ribs is connected to the heater body of the heater assembly. The first rib and the second rib are arranged to be symmetrical with respect to a centerline extending in the belt moving direction midway between the first side edge and second side edge of the fuser belt.

The invention, in another form thereof, is directed to an imaging apparatus for forming a toner image on a sheet of print media. A media feed section feeds the sheet of print media along a media feed path in a sheet feed direction. A laser scanning device is configured to produce a scanned light beam. An image-forming device having a photosensitive body is configured to use the scanned light beam to form a latent image on the photosensitive body and develop the latent image to form a toner image that is transferred to the sheet of print media. A fuser assembly includes a first end cap, and a second end cap spaced apart from the first end cap along an axis that is orthogonal to the sheet feed direction. A fuser belt has a first side edge, a second side edge spaced apart from the first side edge, an exterior surface, an interior surface, and a hollow interior defined by the interior surface. The fuser belt contacts a backup roller to form a nip. The fuser belt defines a belt moving direction at the nip corresponding to the sheet feed direction. A heater assembly is located in the hollow interior of the fuser belt. The heater assembly includes a heater housing and a heater body coupled to the heater housing. The heater body is positioned to contact the interior surface of the fuser belt. A plurality of ribs is positioned to contact the interior surface of the fuser belt, wherein a first rib of the plurality of ribs is connected to one of the first end cap and the heater assembly, and a second rib of the plurality of ribs is connected to one of the second end cap and the heater assembly. Each of the plurality of ribs is oriented to longitudinally extend at an acute angle with respect to the belt moving direction.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic representation of an electrophotographic imaging apparatus configured in accordance with an embodiment of the present invention.

FIG. 2 is a diagrammatic side view of a fuser assembly of the imaging apparatus of FIG. 1 with an end cap removed to expose the heater assembly.

FIG. 3 is a diagrammatic front view of the fuser assembly of the imaging apparatus of FIG. 1.

FIG. 4 is a bottom view of the heater assembly of the fuser assembly of FIGS. 2 and 3 configured in accordance with an embodiment of the present invention.

FIG. 5 is a side view of the heater body of the heater assembly of FIG. 4.

FIG. 6 is a bottom view of a variation of the heater assembly of FIGS. 4 and 5, in accordance with another embodiment of the present invention.

FIG. 7 is a top view of the fuser assembly of FIG. 3 with the fuser belt shown by phantom lines, and with the end caps configured in accordance with another embodiment of the present invention.

FIG. 8 is a side view of another embodiment of the present invention that combines the embodiments of FIGS. 6 and 7, with the fuser belt shown by phantom lines.

FIG. 9 is a side view of another embodiment of the present invention, which is a variation of the embodiment of FIG. 8, with the fuser belt shown by phantom lines.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

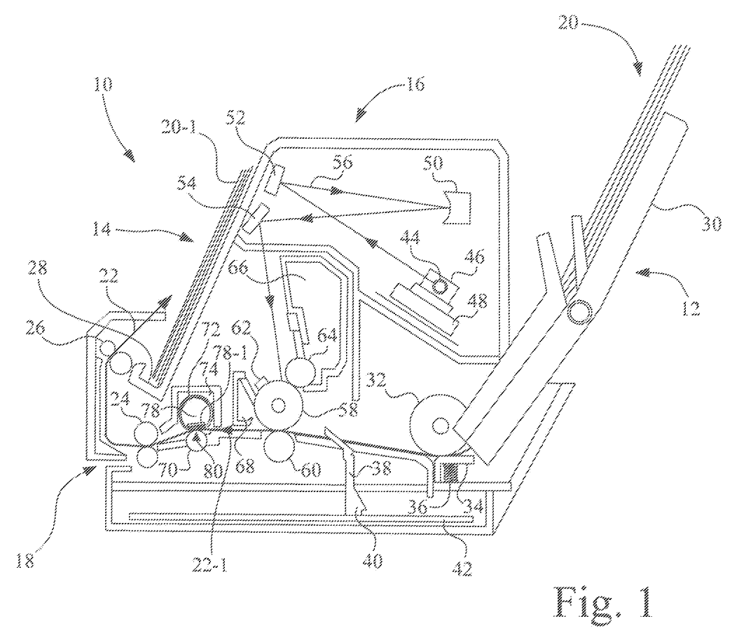

Referring now to the drawings and particularly to FIG. 1, there is shown an exemplary electrophotographic imaging apparatus 10, e.g., a laser printer and/or copier, configured in accordance with an embodiment of the present invention. Imaging apparatus 10 includes a media feed section 12, an image-forming device 14, a laser scanning device 16, and a fuser assembly 18.

Media feed section 12 sequentially transports a sheet of print media (e.g., paper) 20-1 from a stack of sheets of print media 20 to image-forming device 14. Each sheet of print media 20-1 moves along a media feed path 22 in a sheet feed direction 22-1. Image-forming device 14 transfers a toner image to the transported sheet of print media 20-1. Fuser assembly 18 fixes the toner image to the sheet of print media 20-1 sent from image-forming device 14. Thereafter, the sheet of print media 20-1 is ejected out of imaging apparatus 10 by media transport rollers 24, 26 and into output tray 28.

In the exemplary imaging apparatus 10, the media feed section 12 includes a feed tray 30, a feed roller 32, a media separating friction plate 34, a pressure spring 36, a media detection actuator 38, a media detection sensor 40, and a control circuit 42. Upon receiving a print instruction, the sheets of print media 20 which have been placed in media feed tray 30 are fed one-by-one by operation of feed roller 32, media separating friction plate 34 and pressure spring 36. As the fed sheet of print media 20-1 pushes down media detection actuator 38, media detection sensor 40 outputs an electrical signal instructing commencement of printing of the image. Control circuit 42, started by operation of media detection actuator 38, transmits an image signal to a laser diode light-emitting unit 44 of laser scanning device 16 so as to control the ON/OFF condition of its associated light-emitting diode.

Laser scanning device 16 includes laser diode light-emitting unit 44, a scanning mirror 46, a scanning mirror motor 48, and reflecting mirrors 50, 52, and 54. Scanning mirror 46 is rotated at a constant high speed by scanning mirror motor 48 such that laser light beam 56 scans in a vertical direction to the print media surface. The laser light beam 56 radiated by laser diode light-scanning unit 44 is reflected by reflecting mirrors 50, 52, and 54 so as to be applied to a photosensitive body 58 of image-forming device 14. When the laser light beam 56 is applied to photosensitive body 58, photosensitive body 58 is selectively exposed to the laser light beam 56 in accordance with ON/OFF information from control circuit 42.

In addition to photosensitive body 58, image-forming device 14 includes a transfer roller 60, a charging member 62, and a developer, including a developing roller 64, a developing unit 66, and a cleaning unit 68. The surface charge of photosensitive body 58, charged in advance by charging member 62, is selectively discharged by the laser light beam 56. An electrostatic latent image is thus formed on the surface of photosensitive body 58. The electrostatic latent image is visualized by developing roller 64, and developing unit 66. Specifically, the toner supplied from developing unit 66 is adhered to the electrostatic latent image on photosensitive body 58 by developing roller 64 so as to form the toner image.

Toner used for development is stored in developing unit 66. The toner contains coloring components (such as carbon black for black toner) and thermoplastic components. The toner, charged by being appropriately stirred in developing unit 66, adheres to the above-mentioned electrostatic latent image by an interaction of the developing bias voltage applied to developing roller 64 and an electric field generated by the surface potential of photosensitive body 58, and thus conforms to the latent image, forming a visual toner image on photosensitive body 58. The toner typically has a negative charge when it is applied to the latent image, forming the visual toner image.

The sheet of print media 20-1 transported from media feed section 12 is transported downstream while being pinched by photosensitive body 58 and transfer roller 60. The sheet of print media 20-1 arrives at the transfer nip in timed coordination with the toned image on the photosensitive body 58. As the sheet of print media 20-1 is transported downstream, the toner image formed on photosensitive body 58 is electrically attracted and transferred to the sheet of print media 20-1 by an interaction with the electrostatic field generated by transfer voltage applied to transfer roller 60. Any toner that still remains on photosensitive body 58, not having been transferred to the sheet of print media 20-1, is collected by cleaning unit 68. Thereafter, the sheet of print media 20-1 is transported to fuser assembly 18.

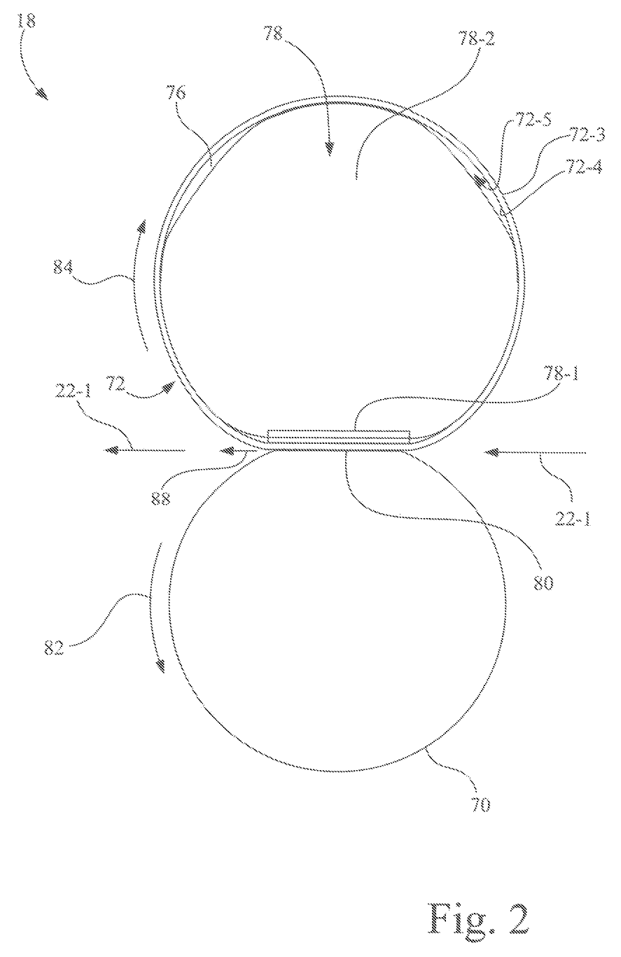

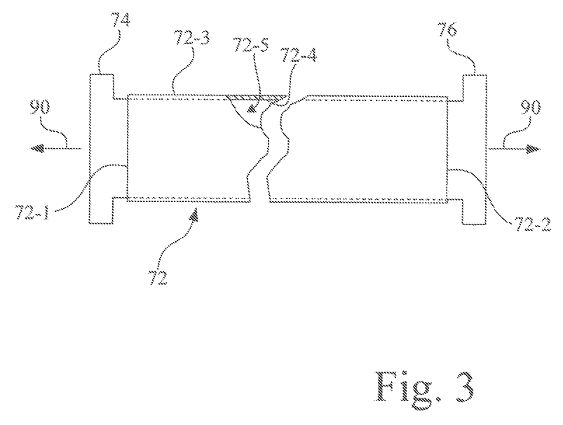

Referring also to FIGS. 2 and 3, fuser assembly 18 may include a backup roller 70, a fuser belt 72, a plurality of end caps 74, 76, and a heater assembly 78. Backup roller 70 and fuser belt 72 are positioned to form a fuser nip 80. Fuser belt 72 is mounted to imaging apparatus 10 via end cap 74 and end cap 76. As illustrated in FIG. 2, a rotation of backup roller 70 in rotational direction 82 results in a corresponding reverse rotation of fuser belt 72 in rotational direction 84, and fuser belt 72 moves in a belt moving direction 88 at fuser nip 80 in a direction corresponding to sheet feed direction 22-1.

The backup (i.e., pressure) roller 70 may be generally cylindrical in shape. Backup roller 70 may be made from, or is coated with, a material that has good release and transport properties for the sheet of print media 20-1. Backup roller 70 may be sufficiently soft so as to allow if to be rotated against fuser belt 72 to form fuser nip 80 through which the printed sheets of print media 20 travel. As a printed sheet of print media 20-1 passes through fuser nip 80, the sheet is placed under pressure, and the combined effects of this pressure, the time the sheet is in fuser nip 80, and the heat from fuser belt 72 acts to fix the toner onto the sheet of print media 20-1. Typically, the pressure between fuser belt 72 and backup roller 70 at fuser nip 80 is from about 5 pound per square inch (psi) to 30 psi.

Backup roller 70 may be formed, for example, from silicone rubber. Backup roller 70 may have an aluminum core with a silicone rubber layer molded or adhesively bonded onto its surface. Backup roller 70 may also have a fluoropolymer, e.g., Teflon, (R) sleeve or coating. Backup roller 70 may be essentially hollow, having a metallic core, an outer metallic shell surrounding and essentially concentric with the core, and ribs between the core and the outer shell.

Fuser belt 72 is an endless belt having a first side edge 72-1, a second side edge 72-2, an exterior surface 72-3, an interior surface 72-4, and a hollow interior 72-5 that is defined by interior surface 72-4. Second side edge 72-2 is spaced apart from first side edge 72-1, with both exterior surface 72-3 and interior surface 72-4 extending therebetween. Fuser belt 72 is formed from a highly heat resistive and durable material having good parting properties and may have a thickness about 75 microns or less. Fuser belt 72 may be formed, for example, from a polyimide film or metal. Fuser belt 72 may have an outer coating of, for example, a fluororesin or Teflon® material to optimize release properties of the fixed toner. Fuser belt 72 may be shaped, for example, as a tube. Fuser belt 72 is positioned between and supported by end cap 74 and end cap 76. Additional support for fuser belt 72 is provided by heater assembly 78.

As illustrated in FIG. 3, end caps 74, 76 may be configured to be structurally mirror images of one another, i.e., configured to be substantially identical. End cap 74 is spaced apart from end cap 76 along an axis 90 that is orthogonal to sheet feed direction 22-1. End caps 74, 76 are positioned to control an axial location of fuser belt 72 along axis 90. The approximate outer support surface of each of end caps 74, 76 is a shape to match the shape that fuser belt 72 wants to take when fuser belt 72 is pressed up against heater assembly 78 by backup roller 70, as illustrated for example in FIG. 2. Axis 90 passes through hollow interior 72-5 of fuser belt 72. Fuser belt 72 rotates around axis 90 in rotational direction 84, and in belt moving direction 88 (i.e., sheet feed direction 22-1) at fuser nip 80.

Heater assembly 78 applies an appropriate temperature and pressure to fuser belt 72 while the sheet of print media 20-1 is moving through fuser nip 80 formed by backup roller 70 and fuser belt 72. The thermoplastic components of the toner on the sheet of print media 20-1 are melted by fuser belt 72 and fixed to the sheet of print media 20-1 to form the fixed image. The sheet of print media 20-1 is then transported and ejected out of the printer by media transport rollers 24, 26 and into output tray 28 where it may be stacked, one sheet upon another.

As illustrated in FIG. 2, heater assembly 78 is located in hollow interior 72-5 of fuser belt 72. Heater assembly 78 includes a heater body 78-1 and a heater housing 78-2. Heater housing 78-2 is configured to mount heater body 78-1, and may be formed from a plastic material. Also, when fuser assembly 18 is assembled, each end cap 74 and 76 is attached to heater housing 78-2. Heater body 78-1 may be formed, for example, using a ceramic substrate having a series of thick film printed resistive materials, conductive materials, and insulative materials. Heater body 78-1 is positioned to contact interior surface 72-4 of fuser belt 22, so that heater assembly 78 is thermally coupled to fuser belt 72. Oil provides lubrication between interior surface 72-4 of fuser belt 72 and heater body 78-1.

In accordance with the present invention, features in the form of a plurality of ribs located on heater assembly 78 and/or the two end caps 74, 76 are positioned to contact interior surface 72-4 of fuser belt 72, and are oriented to reduce the possibility of the oil in fuser assembly 18 leaking out, so as maintain an effective lubrication condition between fuser belt 72 and heater assembly 78.

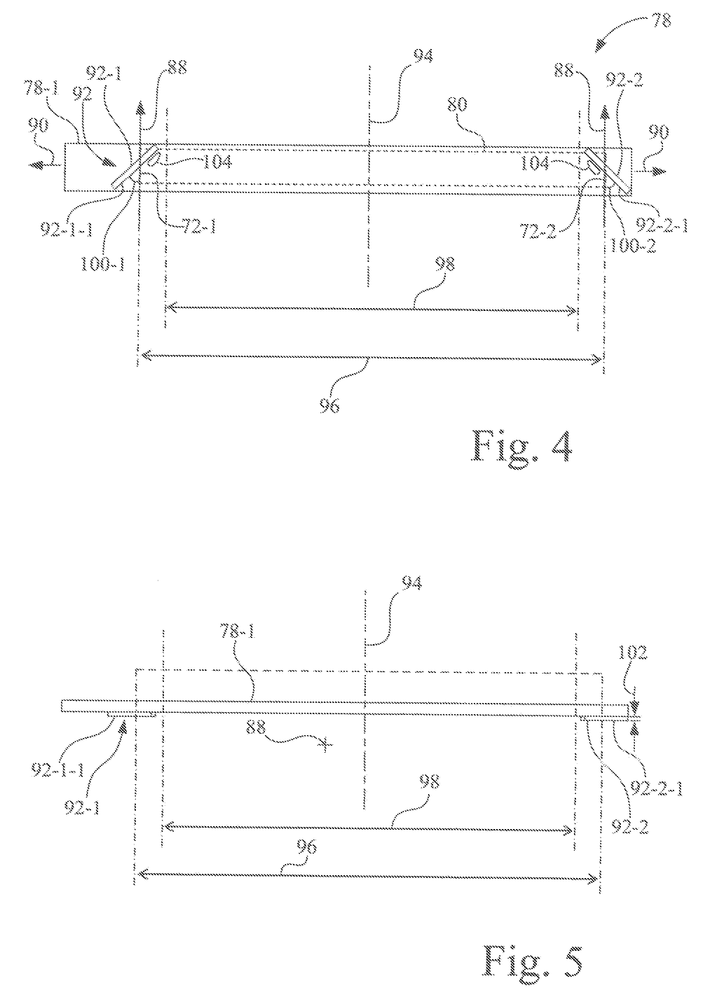

FIGS. 4 and 5 illustrate one embodiment in accordance with the present invention, wherein a plurality of ribs 92, including a first rib 92-1 and a second rib 92-2, are connected to heater body 78-1 of heater assembly 78. The term “connected” includes both embodiments wherein the plurality of ribs 92 are applied, e.g., as glass layers, to a surface of heater body 78-1, as well as embodiments wherein the plurality of ribs 92 are formed integral with heater body 78-1. The plurality of ribs 92, including a first rib 92-1 and a second rib 92-2, are positioned to contact interior surface 72-4 of fuser belt 72. First rib 92-1 and second rib 92-2 may be arranged to be symmetrical with respect to a centerline 94 that extends in belt moving direction 88, midway between first side edge 72-1 and second side edge 72-2 of fuser belt 72.

In FIGS. 4 and 5, distance 96 represents the width of backup roller 70 parallel to ash 90 that is orthogonal to belt moving direction 88 and in turn sheet feed direction 22-1. Distance 98 represents the width of the sheet of print media 20-1 along axis 90 that is orthogonal to belt moving direction 88 and in turn sheet feed direction 22-1. The dashed rectangle represents fuser nip 80. In FIG. 5, a plus sign (+) is used to designate that belt moving direction 88 projects out of the page toward the reader.

Each of the plurality of ribs 92 is oriented to longitudinally extend at an acute angle with respect to belt moving direction 88. For example, first rib 92-1 is oriented at a first angle 100-1 with respect to belt moving direction 88. Second rib 92-2 is oriented at a second angle 100-2 with respect to belt moving direction 88. In the present embodiment, first angle 100-1 and second angle 100-2 may be symmetrical acute angles. Each of first angle 100-1 and second angle 100-2 is in a range of 10 degrees to 80 degrees, with a preferred angle in one embodiment being 45 degrees. In the present embodiment, a height 102 of each of the plurality of ribs 92 is one millimeter or less, with a preferred height in one embodiment being between 0.05 and 0.1 millimeters.

With the orientation of ribs 92-1, 92-2 as illustrated in the embodiment of FIGS. 4 and 5, as fuser belt 72 is moved in belt moving direction 88 at fuser nip 80, oil 104 that may be migrating outwardly toward side edges 72-1, 72-2 of fuser belt 72 is redirected inwardly toward centerline 94 as oil 104 engages ribs 92-1, 92-2. Thus, when fuser belt 72 moves along the surface of heater body 78-1, the incoming edges (e,g., a first leading portion 92-1-1 and a second leading portion 92-2-1) of first rib 92-1 and second rib 92-2 scrape the oil 104 from interior surface 72-4 of fuser belt 72 and push the oil 104 inwardly due to the respective angles 100-1, 100-2 that respective ribs 92-1, 92-2 are oriented. In this way, the oil 104 moving towards the side edges 72-1, 72-2 of fuser belt 72 is pushed back to reduce or prevent the leaking of oil from fuser assembly 18.

FIG. 6 is a variation of the embodiment of FIGS. 4 and 5, wherein first rib 92-1 belongs to a first subset of rib members 106-1 of the plurality of ribs 92 and second rib 92-2 belongs to a second subset of rib members 106-2 of the plurality of ribs 92. In the exemplary embodiment of FIG. 6, each of the rib members of said first subset 106-1 are oriented at first angle 100-1 with respect to belt moving direction 88, and may be parallel to one another. Likewise, each of the rib members of second subset 106-2 are oriented at second angle 100-2 with respect to belt moving direction 88, and are parallel to one another. In the present embodiment, first angle 100-1 and second angle 100-2 may be symmetrical acute angles.

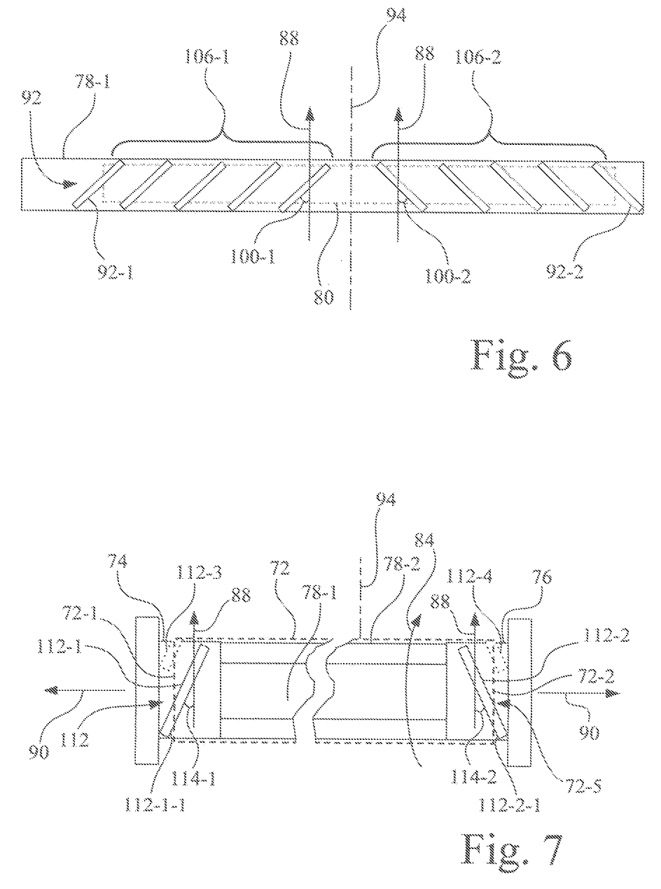

FIG. 7 illustrates another embodiment in accordance with the present invention, having a plurality of ribs 112. The plurality of ribs 112 include a first rib 112-1 connected to end cap 74 and a second rib 112-2 connected to end cap 76. The term “connected” includes both embodiments wherein the plurality of ribs 112 are applied to a surface of the respective end cap, as well as embodiments wherein the plurality of ribs 112 are formed integral with the respective end cap. The plurality of ribs 112, including a first rib 112-1 and a second rib 112-2, are positioned to contact interior surface 72-4 of fuser belt 72. First rib 112-1 and second rib 112-2 may be oriented to be symmetrical, i.e., are mirror images of one another.

Each of the plurality of ribs 112 is oriented to longitudinally extend at an acute angle with respect to belt moving direction 88. For example, first rib 112-1 is oriented at a first angle 114-1 with respect to a plane of rotational direction 84, and in the view of FIG. 7, is oriented at first angle 114-1 with respect to belt moving direction 88. Second rib 112-2 is oriented at a second angle 114-2 with respect to the plane of rotational direction 84, and in the view of FIG. 7, is oriented at second angle 114-2 with respect to belt moving direction 88. In the present embodiment, first angle 114-1 and second angle 114-2 may be symmetrical acute angles. Each of first angle 114-1 and second angle 114-2 is in a range of 10 degrees to 80 degrees. In the present embodiment a height of each of the plurality of ribs 112 is one millimeter or less, with a preferred height in one embodiment being between 0.05 and 0.1 millimeters.

As illustrated diagrammatically in FIG. 7, a first leading portion 112-1-1 of first rib 112-1 extends outside of hollow interior 72-5 beyond first side edge 72-1 of fuser belt 72. Also, a second leading portion 112-2-1 of second rib 112-2 extends outside of hollow interior 72-5 beyond second side edge 72-2 of fuser belt 72.

In the embodiment of FIG. 7, in its simplest form only one rib is located on each of end caps 74, 76. However, it is contemplated that supplemental ribs, e.g., ribs 112-3, 112-4 shown in dotted lines, may be located on each end cap 74, 70, respectively, and wind around a portion of each end cap in the same fashion as ribs 112-1 and 112-2.

FIG. 8 illustrates another embodiment in accordance with the present invention, which is essentially a combination of the embodiments of FIGS. 6 and 7, showing third rib 112-3 connected to end cap 74 and fourth rib 112-4 connected to end can 76, as well as having the first subset of rib members 106-1 of the plurality of ribs 92 and the second subset of rib members 106-2 of the plurality of ribs 92 connected to heater body 78-1. Each of the plurality of ribs 112 is oriented to longitudinally extend at an acute angle with respect to belt moving direction 88. In FIG. 8, a plus sign (+) is used to designate that belt moving direction 88 projects out of the page toward the reader.

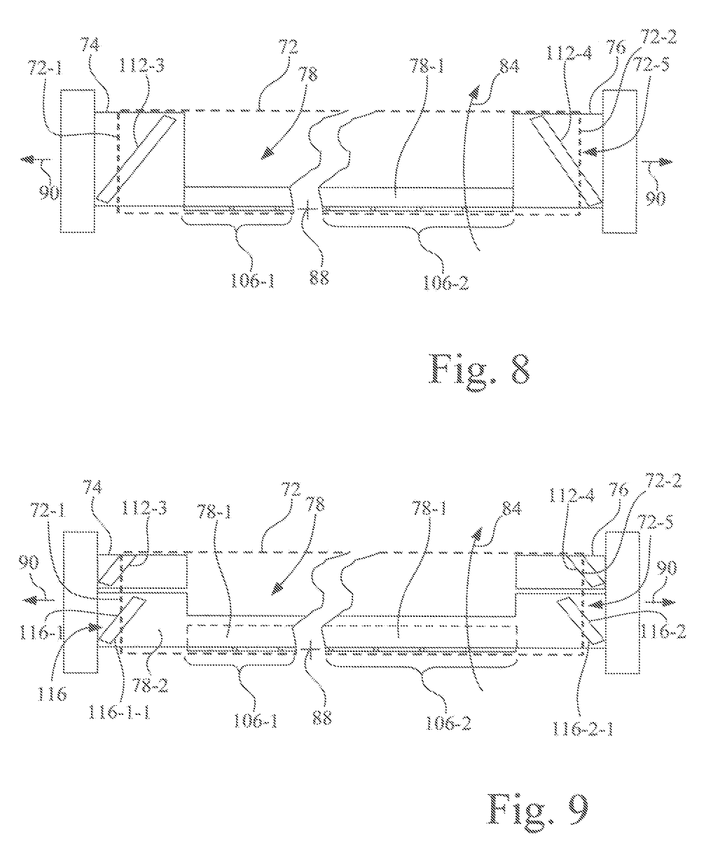

FIG. 9 illustrates another embodiment in accordance with the present invention, wherein oil retention ribs are included on each of end caps 74, 76, and each of heater body 78-1 and heater housing 78-2. FIG. 9 is a variation of the embodiment of FIG. 8, wherein a plurality of ribs 116, e.g., rib 116-1 and rib 116-2, are connected to heater housing 78-2. The term “connected” includes both embodiments wherein the plurality of ribs 116 are applied to a surface of heater housing 78-2, as well as embodiments wherein the plurality of ribs 116 are formed integral with heater housing 78-2. Also, as shown in the orientation of the embodiment of FIG. 9, third rib 112-3 is connected to end cap 74, fourth rib 112-4 Is connected to end cap 76, and the first subset of rib members 106-1 of the plurality of ribs 92 and the second subset of rib members 106-2 of the plurality of ribs 92 are connected to heater body 78-1. In FIG. 9, a plus sign (+) is used to designate that belt moving direction 88 projects out of the page toward the reader.

Each of the plurality of ribs 116 is oriented to longitudinally extend at an acute angle, e.g., in a range of 10 degrees to 80 degrees, with respect to belt moving direction 88 and the plane of rotational direction 84. Rib 116-1 and rib 116-2 may be oriented, for example, to be symmetrical, i.e., are mirror images of one another, with respect to a central region of the fuser assembly along axis 90. In the present embodiment, a height of each of the plurality of ribs 116 is one millimeter or less, with a preferred height in one embodiment being between 0.05 and 0.1 millimeters.

As illustrated diagrammatically in FIG. 9, a first leading portion 116-1 of rib 116-1 may extend outside of hollow interior 72-5 of fuser belt 72 beyond first side edge 72-1 of fuser belt 72. Also, a second leading portion 116-2-1 of second rib 116-2 may extend outside of hollow interior 72-5 of fuser belt 72 beyond second side edge 72-2 of fuser belt 72.

In the embodiments described above (see, for example, FIGS. 4-9), for each rib, the inwardly facing edge of the rib is shown as a straight line. However, those skilled in the art will recognize that other shapes, such as a curved shape, may be used in guiding oil 104 toward the central region of fuser belt 72, e.g., toward centerline 94.

As an exemplary benefit of the present invention, it is possible to use a much lower viscosity lubricant, e.g., oil, than is possible in the absence of the present invention, since as fuser belt 72 is rotated the lubricant is moved toward the central region of fuser belt 72 and away from side edges 72-1, 72-2. Using a lower viscosity lubricant in turn not only leads to lower torque and lower wear associated with fuser belt 72, but also to better fuse grade/fusing quality by yielding in a thinner oil film thickness and/or lower contact resistance between heater assembly 78 and fuser belt 72.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A fuser assembly configured to fix a toner image to a sheet of print media moving in a sheet feed direction through a nip, said baser assembly comprising:
a first end cap;
a second end cap spaced apart from said first end cap along an axis that is orthogonal to said sheet feed direction.
a fuser belt having a first side edge, a second side edge spaced apart from said first side edge, an exterior surface, an interior surface, and a hollow interior defined by said interior surface, said fuser belt being positioned between and supported by said first end cap and said second end cap, with said axis passing through said hollow interior, to rotate around said axis in a belt moving direction at said nip corresponding to said sheet feed direction;
a heater assembly located in said hollow interior of said fuser belt, said heater assembly including a heater housing and a heater body coupled to said heater housing, said heater body being positioned to contact said interior surface of said fuser belt; and
a plurality of ribs positioned to contact said interior surface of said fuser belt, wherein a first rib of said plurality of ribs is connected to one of said first end cap and said heater assembly, and a second rib of said plurality of ribs is connected to one of said second end cap and said heater assembly, wherein each of said plurality of ribs is oriented to longitudinally extend at an acute angle with respect to said belt moving direction.

2. The fuser assembly of claim 1, wherein said acute angle is in a range of 10 degrees to 80 degrees.

3. The fuser assembly of claim 1, wherein a height of each of said plurality of ribs is less than one millimeter.

4. The fuser assembly of claim 1, wherein said first rib and said second rib are oriented at symmetrical acute angles with respect to said belt moving direction.

5. The fuser assembly of claim 1, wherein a first leading portion of said first rib extends outside of said hollow interior beyond said first side edge of said fuser belt, and a second leading portion of said second rib extends outside of said hollow interior beyond said second side edge of said baser belt.

6. The fuser assembly of claim 5, wherein said first rib is connected to said first end cap and said second rib is connected to said second end cap, and said acute angle associated with said first rib and said second rib is in a range of 10 degrees to 80 degrees.

7. The fuser assembly of claim 1, wherein each of said first rib and said second rib is connected to said heater body, and said acute angle associated with said first rib and said second rib is in a range of 10 degrees to 80 degrees.

8. The fuser assembly of claim 7, wherein said first rib belongs to a first subset of said plurality of ribs and said second rib belongs to a second subset of said plurality of ribs.

9. The fuser assembly of claim 8, wherein members of said first subset of said plurality of ribs are parallel to one another, and members of said second subset of said plurality of ribs am parallel to one another.

10. The fuser assembly of claim 7, wherein members of said first subset of said plurality of ribs are oriented at a first angle with respect to said belt moving direction and members of said second subset of said plurality of ribs are oriented at a second angle with respect to said belt moving direction, said first angle and said second angle being symmetrical acute angles, wherein each of said first angle and said second angle is in a range of 10 degrees to 80 degrees.

11. The fuser assembly of claim 1, wherein each of said first rib and said second rib is connected to said heater housing, and said acute angle associated with said first rib and said second rib is in a range of 10 degrees to 80 degrees.

12. The fuser assembly of claim 1, wherein a first subset of ribs of said plurality of ribs is connected to said first end cap, a second subset of ribs of said plurality of ribs is connected to said second end cap, a third subset of ribs of said plurality of ribs is connected to said heater housing, and a fourth subset of ribs of said plurality of ribs is connected to said heater body, wherein each subset of ribs includes at least one rib.

13. A fuser assembly configured to fix a toner image to a sheet of print media moving in a sheet feed direction through a nip, said fuser assembly comprising:
a first end cap;
a second end cap spaced apart from said first end cap along an axis that is orthogonal to said sheet feed direction,
a fuser belt having a first side edge, a second side edge spaced apart from said first side edge, an exterior surface, an interior surface, and a hollow interior defined by said interior surface, said fuser belt being positioned between and supported by said first end cap and said second end cap, with said axis passing through said hollow interior, to rotate in a rotational direction around said axis in a belt moving direction at said nip corresponding to said sheet feed direction;
a heater assembly located in said hollow interior of said fuser belt, said heater assembly including a heater housing and a heater body coupled to said heater housing, said heater body being positioned to contact said interior surface of said fuser belt; and
a plurality of ribs positioned to contact said interior surface of said fuser belt, wherein a first rib of said plurality of ribs is connected to said first end cap and a second rib of said plurality of ribs is connected to said second end cap, said first rib and said second rib being oriented to be symmetrical.

14. The fuser assembly of claim 13, wherein a first leading portion of said first rib extends outside of said hollow interior beyond said first side edge of said fuser belt, and a second leading portion of said second rib extends outside of said hollow interior beyond said second side edge of said fuser belt.

15. The fuser assembly of claim 13, wherein said first rib is oriented at a first angle with respect to a plane of rotational direction of said fuser belt and said second rib is oriented at a second angle with respect to said plane of said rotational direction, said first angle and said second angle being symmetrical acute angles.

16. The fuser assembly of claim 15, wherein each of said first angle and said second angle is in a range of 10 degrees to 80 degrees.

17. The fuser assembly of claim 15, further comprising a second plurality of ribs connected to said heater body, wherein a first portion of said second plurality of ribs is oriented at a third angle with respect to said belt moving direction and a second portion of said second plurality of ribs is oriented at a fourth angle with respect to said belt moving direction, said third angle and said fourth angle being symmetrical acute angles.

18. The fuser assembly of claim 17, wherein each of said third angle and said fourth angle is in a range of 10 degrees to 80 degrees.

19. A fuser assembly configured to fix a toner image to a sheet of print media moving in a sheet feed direction through a nip, said fuser assembly comprising:
a first end can;
a second end cap spaced apart from said first end cap along an axis that is orthogonal to said sheet feed direction,
a fuser belt having a first side edge, a second side edge spaced apart from said first side edge, an exterior surface, an interior surface, and a hollow interior defined by said interior surface, said fuser belt being positioned between and supported by said first end cap and said second end cap, with said axis passing through said hollow interior, to rotate around said axis in a belt moving direction at said nip corresponding to said sheet feed direction;
a heater assembly located in said hollow interior of said fuser belt, said heater assembly including a heater housing and a heater body coupled to said heater housing; and
a plurality of ribs positioned to contact said interior surface of said fuser belt wherein a first rib of said plurality of ribs is connected to said heater body of said heater assembly, and a second rib of said plurality of ribs is connected to said heater body of said heater assembly, said first rib and said second rib being arranged to be symmetrical with respect to a centerline extending in said belt moving direction midway between said first side edge and second side edge of said fuser belt.

20. The fuser assembly of claim 19, wherein said first rib is oriented at a first angle with respect to said belt moving direction and said second rib is oriented at a second angle with respect to said belt moving direction, said first angle and said second angle being symmetrical acute angles, wherein each of said first angle and said second angle is in a range of 10 degrees to 80 degrees.

21. The fuser assembly of claim 19, wherein said first rib belongs to a first subset of said plurality of ribs and said second rib belongs to a second subset of said plurality of ribs, wherein rib members of said first subset of said plurality of ribs are oriented at a first acute angle with respect to said belt moving direction and rib members of said second subset of said plurality of ribs are oriented at a second acute angle with respect to said belt moving direction.

22. An imaging apparatus for forming a toner image on a sheet of print media, comprising:
a media feed section for feeding said sheet of print media along a media feed path in a sheet feed direction;
a laser scanning device configured to produce a scanned light beam;
an image-forming device having a photosensitive body, and configured to use said scanned light beam to form a latent image on said photosensitive body and develop said latent image to form a toner image that is transferred to said sheet of print media; and
a fuser assembly, including:
a first end cap;
a second end can spaced apart from said first end cap along an axis that is orthogonal to said sheet feed direction,
a backup roller;
a fuser belt having a first side edge, a second side edge spaced apart from said first side edge, an exterior surface, an interior surface, and a hollow interior defined by said interior surface, said fuser belt contacting said backup roller to form a nip, said fuser belt defining a belt moving direction at said nip corresponding to said sheet feed direction;
a heater assembly located in said hollow interior of said baser belt, said heater assembly including a heater housing and a heater body coupled to said heater housing, said heater body being positioned to contact said interior surface of said fuser belt; and
a plurality of ribs positioned to contact said interior surface of said fuser belt, wherein a first rib of said plurality of ribs is connected to one of said first end cap and said heater assembly, and a second rib of said plurality of ribs is connected to one of said second end cap and said heater assembly, wherein each of said plurality of ribs is oriented to longitudinally extend at an acute angle with respect to said belt moving direction.

23. The imaging apparatus of claim 22, wherein said acute angle is in a range of 10 degrees to 80 degrees, and a height of each of said plurality of ribs is less than one millimeter,

24. The imaging apparatus of claim 22, wherein said first rib belongs to a first subset of said plurality of ribs and said second rib belongs to a second subset of said plurality of ribs, wherein members of said first subset of said plurality of ribs are oriented at a first angle with respect to said belt moving direction and members of said second subset of said plurality of ribs are oriented at a second angle with respect to said belt moving direction, said first angle and said second angle being acute angles.
